(19) United States
(12) Patent Application Publication
(10) Pub. No.: US 2019/0230893 A1
(43) Pub. Date: Aug. 1, 2019

(54) BOX FOR TRANSPORTING LIVE ANIMALS, PARTICULARLY OF THE TYPE OF LABORATORY MICE AND/OR RATS

(71) Applicant: I.S. IMBALLAGGI SPECIALI SRL, Mezzago (IT)

(72) Inventor: Giuseppe ERRANTE, Monza (IT)

(73) Assignee: I.S. Imballaggi Speciali Srl, Mezzago (IT)

(21) Appl. No.: 16/319,001

(22) PCT Filed: Jul. 11, 2017
(86) PCT No.: PCT/EP2017/067437

§ 371 Date: Jan. 18, 2019

(30) Foreign Application Priority Data
Jul. 21, 2016 (IT) 102016000076403

(51) Int. Cl. A01K 1/02; A01K 1/03; A01K 1/00

(52) U.S. Cl. CPC A01K 1/0245; A01K 1/0064; A01K 1/031

(57) ABSTRACT

A box for transporting live animals, particularly of the type of laboratory mice and/or rats, which comprises a base, four side walls and a lid, at least one of the side walls comprising at least one opening for ventilating the internal volume of the box, a protective mesh made of a material such as metal being associated with the at least one opening; the base and the four side walls are made of a material such as polypropylene.

The present invention relates to a box for transporting live animals, particularly of the type of laboratory mice and/or rats.

Currently the shipping of live laboratory animals to research and experimentation laboratories belonging to research organizations or to pharmaceutical industries is done by using a corrugated cardboard box on the inside of which a sheet of siliconized paper is applied. Such sheet is necessary to protect the cardboard from the chemical/physical actions of the excrement of the animals.

Furthermore, in order to protect the cardboard from attack by the animals, metal meshes and PVC sheets are used to cover the entire inner surface of the box.

For example the protective metal mesh is generally die-cut together with the corrugated cardboard, also die-cut, that forms the body of the box, and is fixed thereto by way of sewing with metal stitches.

A PVC sheet is generally applied to the lid which impedes aggression from the animals.

When it is to be used, the box is inserted, in order to be filled, into the entry openings of the cleanrooms used to raise and breed the animals. Once it has been filled with the animals, sawdust and hydrogel packs, necessary to feed the animals during transport, are placed inside the box.

Such conventional boxes are not devoid of drawbacks, among which is the fact that they are complex to make.

A further drawback of such conventional boxes consists in that they cannot be disposed of economically and ecologically.

In fact they are classified as hazardous waste, and therefore they must be disposed of by specialist third-party companies, with considerable costs of disposal.

Furthermore, the impossibility of separating the various components, and especially of removing the metal mesh from the cardboard, makes it impossible to recycle the box.

The aim of the present invention consists in providing a box for transporting live animals, particularly of the type of laboratory mice and/or rats, that solves the above technical problems, eliminates the drawbacks and overcomes the limitations of the known art.

Within this aim, an object of the present invention is to provide a box that is completely hygienic.

Another object of the present invention consists in providing a box that is unassailable by fungi and mildew, and which does not permit bacterial proliferation.

Another object of the present invention consists in providing a box that can be made from materials that are chemically and biologically inert.

Another object of the present invention consists in providing a box that can be sterilized and which is completely and easily recyclable.

Another object of the present invention consists in providing a box that can be easily and economically transported and distributed even before filling it with the animals.

Another object of the present invention consists of providing a box that is capable of offering the widest guarantees of reliability and safety in use.

Another object of the present invention consists in providing a box that is easy to implement and economically competitive when compared to the known art.

This aim and these and other objects which will become better apparent hereinafter are achieved by a box for transporting live animals, particularly of the type of laboratory mice and/or rats, which comprises a base, four side walls and a lid, at least one of said side walls comprising at least one opening for ventilating the internal volume of said box, a protective mesh made of a material such as metal being associated with said at least one opening, characterized in that said base and said four side walls are made of a material such as polypropylene.

Further characteristics and advantages of the invention will become better apparent from the detailed description of a preferred, but not exclusive, embodiment of a box for transporting live animals, particularly of the type of laboratory mice and/or rats, which is illustrated by way of non-limiting example with the aid of the accompanying drawings wherein:

FIG. 1 is a perspective view of an embodiment of a box, according to the invention;

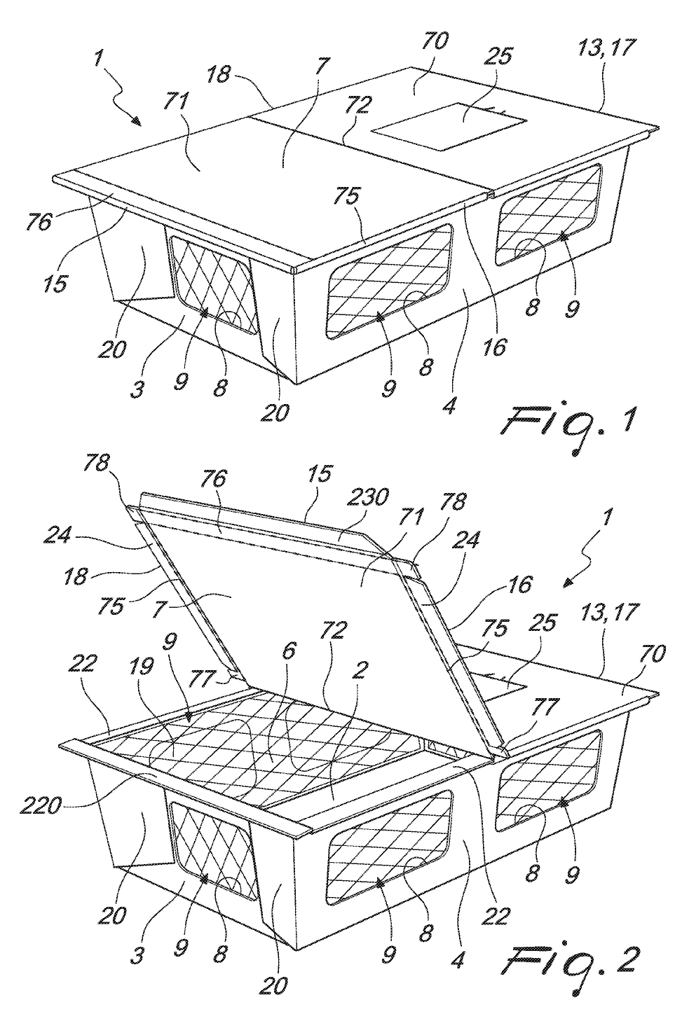

FIG. 2 is a perspective view of the box of FIG. 1, according to the invention, partially open;

FIG. 3 is a plan view from above of the die-cut body of the box, according to the invention;

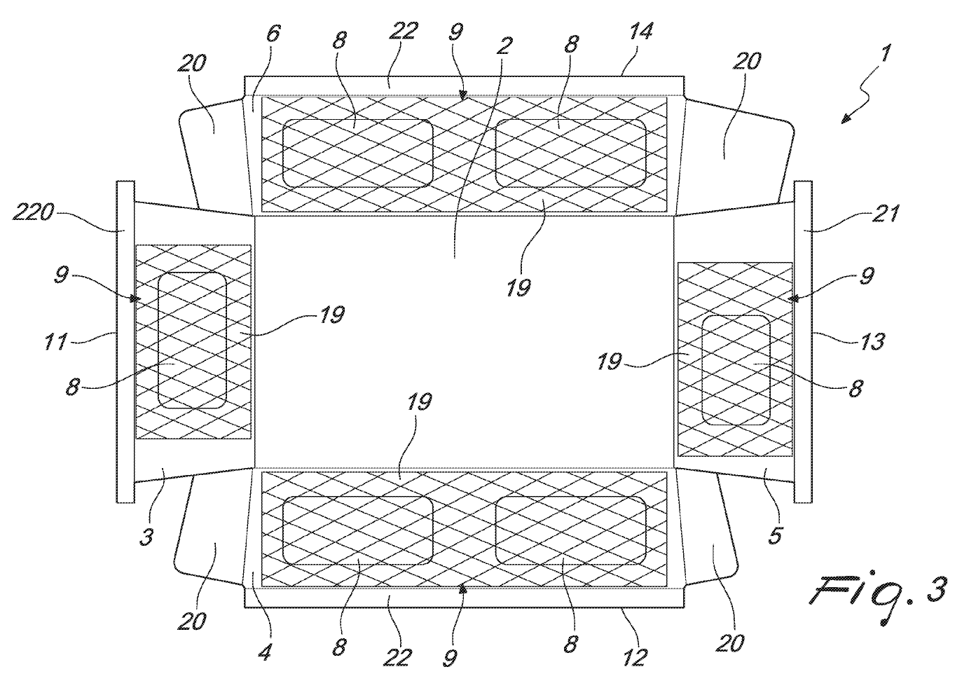

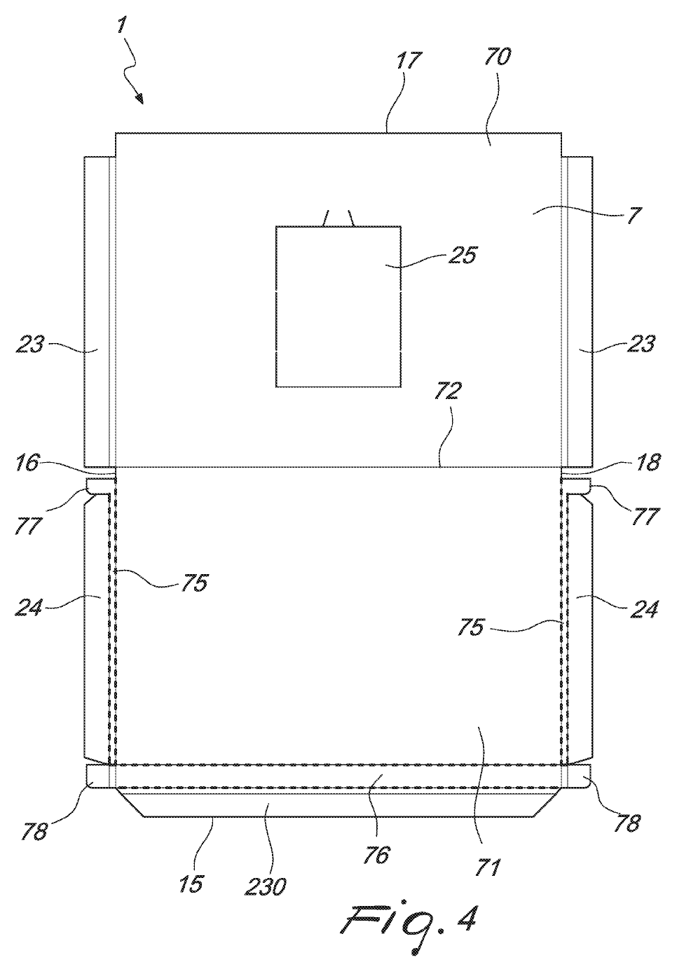

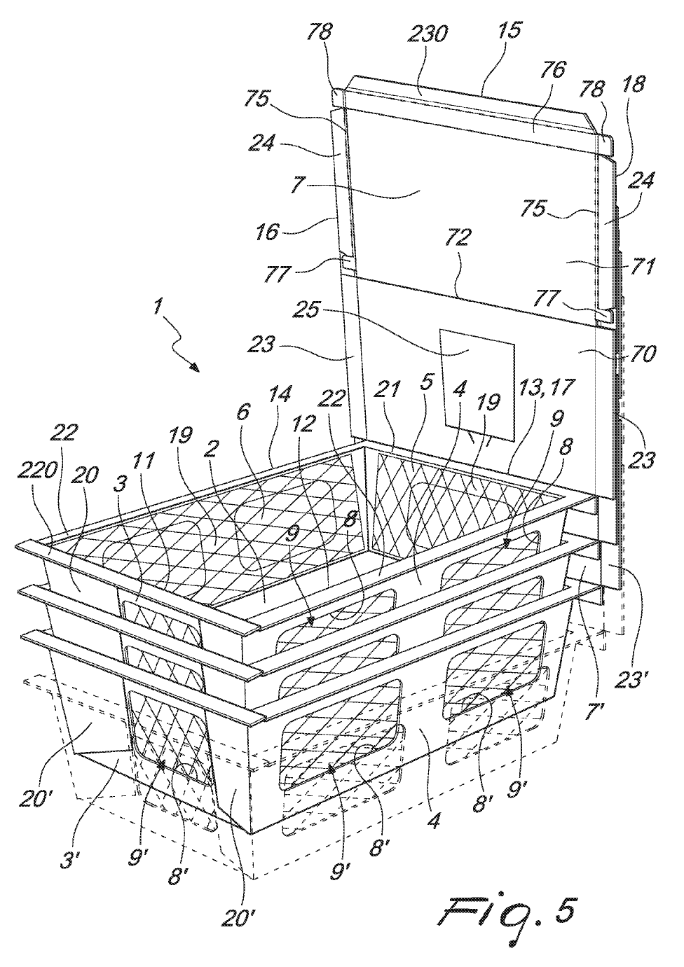

FIG. 4 is a plan view from above of the die-cut lid of the box, according to the invention;

FIG. 5 shows an example of stacking a plurality of boxes, according to the invention.

With reference to the figures, the box for transporting live animals, particularly of the type of laboratory mice and/or rats, generally designated by the reference numeral 1, comprises a base 2, four side walls 3, 4, 5, 6 and a lid 7.

At least one of the side walls 3, 4, 5, 6 comprises at least one opening 8 for ventilating the internal volume of the box 1, with which a protective mesh 9 made of a material such as metal is associated.

Advantageously the protective mesh 9 can be made of a material such as steel.

According to the invention, the base 2 and the four side walls 3, 4, 5, 6 are made of a material such as polypropylene.

Advantageously the lid 7 is also made of a material such as polypropylene.

In particular, the base 2 and the side walls 3, 4, 5, 6 can be die-punched starting from an extruded polypropylene sheet.

Advantageously the lid 7 can also be die-cut starting from an extruded polypropylene sheet.

Advantageously the four side walls 3, 4, 5, 6 are mutually joined by way of hot glue for food use.

The hot glue is advantageously applied to the corner tabs for gluing 20, which are present at the corners of the base 2, between one side wall and the next. Advantageously the side walls are sealed, at the corners, at the corner tabs, in order to prevent the egress of animal excrement.

Advantageously the lid 7 is pivoted to the upper edge 13 of one side wall 5 of the four side walls 3, 4, 5, 6 that are present.

In particular, the lid 7 advantageously comprises one side 17 that is fixed by way of hot glue for food use to a tab for gluing 21 which is present at the upper edge 13 of the side wall 5.

Preferably the pivoting between the lid 7 and the body of the box 1 is provided at a short side of the box.

The upper edge 11, 12, 14 of at least one side wall 3, 4, 6 can be fixed to a corresponding side 15, 16, 18 of the lid 7 by way of double-sided adhesive tape, in order to stably close the lid 7 on the body of the box 1.

Preferably the box 1 has one side 17 of the lid 7 which is fixed by way of hot glue for food use to an edge 13 of a first side wall 5, and the remaining sides 15, 16, 18 of the lid 7 can be fixed by way of double-sided adhesive tape to the corresponding edges 11, 12, 14 of the remaining side walls 3, 4, 6.

The lid 7 is therefore pivoted to the first side wall 5.

At the edges 11, 12, 14 of the side walls 3, 4, 6 that are not pivoted to the lid 7, there are advantageously two longitudinal tabs 22 and a front tab 220, which are configured to be coupled to corresponding longitudinal tabs 23, 24 and front tabs 230 which are present at the sides 15, 16, 18 of the lid 7 where there is no pivoting with the body of the box 1. The coupling between the tabs 22, 220 of the body of the box 1 and the tabs 23, 24, 230 of the lid 7 occurs by way of double-sided adhesive tape.

Advantageously the lid 7 comprises a window 25 that can be opened if needed in order to allow inspection of the animals.

Advantageously further a sheet of a material such as PVC, preferably transparent, is associated with the inner face of the lid 7, preferably by way of gluing. Such sheet is adapted to prevent the egress of the animals when the inspection window 25 is lifted in order to inspect the animals present in the container.

The side walls 3, 4, 5, 6 are advantageously inclined toward the outside of the box 1 so as to render it stackable with contiguous identical boxes 1′, as illustrated for the purposes of example in FIG. 5. The elements of the box 1′ are indicated with the same reference numerals used for the box 1, but with a notation prime.

In operations to transport the boxes 1, 1′ before they are used to collect the animals, the boxes 1, 1′ can be stacked one on the other, with the corresponding lids 7, 7′ aligned vertically, thus reducing the overall encumbrances.

Advantageously therefore, the boxes 1, 1′ can be transported and distributed, before being used to transport animals, with the lid 7 already uniquely associated with the corresponding body of the box 1.

The box 1 advantageously comprises a sheet 19 made of a material such as non-woven fabric associated with the protective mesh 9.

For example the perimetric edges of the protective mesh 9 can be folded back in order to retain the sheet 19.

Alternatively the sheet 19 can be applied by way of hot glue for food use to the base 2.

Advantageously the protective mesh 9 is arranged only at the ventilation openings 8, since it is not necessary to completely protect the base 2 and the side walls 3, 4, 5, 6 from the excrement and aggression of the animals, since such parts of the box 1 are made of polypropylene.

As illustrated in the accompanying figures, the box 1 comprises a plurality of ventilation openings 8 arranged on the side walls 3, 4, 5, 6. In particular, there can be two ventilation openings 8 on the long walls 4 and 6, and only one opening on the short walls 3 and 5.

With regard to the protective mesh 9, it is sufficient for it to cover the ventilation openings 8, but it is not necessary for it to cover the entire surface inner of the box 1.

The provision and the operation of the box for transporting live animals are clear and evident from the foregoing description.

In particular, the box is provided by way of die-punching a sheet of polypropylene along the profiles of the body of the box, shown in FIG. 3, and of the lid, shown in FIG. 4.

The protection meshes 9 and the protection sheets 19 of non-woven fabric are glued, by way of hot glue for food use, to the flaps that will constitute the side walls 3, 4, 5, 6 of the box 1.

The body of the box 1 is assembled by joining the side walls 3, 4, 5, 6 by way of gluing the corner tabs 20.

The lid 7 is associated with the side wall 5, again by gluing with hot glue for food use. In particular the lid 7 is associated with the edge 13 of only one wall 5, so as to be pivoted thereto.

The box 1 thus assembled is ready to be stacked with other boxes 1′, as shown in FIG. 5, and transported, for example on pallets.

The lid 7 is advantageously subdivided, in a longitudinal direction, into two flaps 70 and 71, separated by a pivoting line 72. The first flap 70 is associated with the longitudinal tabs 23, while the second flap 71 is associated with the longitudinal tabs 24 and the front tab 230.

Before using the box 1, the user closes the first flap 70 of the lid 7 on the body of the box 1 using the double-sided adhesive tape.

The first flap 70 of the lid 7 can be closed by folding the longitudinal tabs 23 of the lid on the corresponding portion of the longitudinal tabs 22 of the body of the box.

At this point the box is ready to be filled with animals, through the opening defined by the second flap 71 of the lid 7.

Once the animals are inserted, the second flap 71 can also be closed, with the double-sided adhesive tape, by folding the longitudinal tabs 24 and the front tab 230 onto the corresponding tabs 22 and 220 of the body of the box. At this point the box 1 is ready to be transported to the desired location, optionally after having placed therein sawdust and hydrogel packs necessary to feed the animal.

Advantageously the lid 7 comprises tear-off strips 75, 76 the perimeter of which is defined by weakening lines.

The tear-off strips 75, 76 are configured to be easily removed by the end user, in order to be able to lift the second region 71 of the lid 7 and so access the animals present therein.

Advantageously the lid 7 comprises a pair of longitudinal tear-off strips 75, each one preferably provided, at one end, with a grip portion 77, and a front tear-off strip 76, which is also preferably provided at one or both of its ends with a grip portion 78.

In order to access the animals present in the box 1 the end user pulls the longitudinal tear-off strips 75 and front 76, optionally taking advantage of the respective grip portions 77, 78, and lifts the second flap 71 of the lid 7, along the pivoting line 72.

In practice it has been found that the box for transporting live animals, particularly of the type of laboratory mice and/or rats, according to the present invention, achieves the intended aim and objects since it makes it possible to transport live animals while ensuring high standards of quality and hygiene.

Another advantage of the box, according to the invention, consists in that, by virtue of the use of polypropylene for the base, the side walls and the lid, the box is unassailable by fungi and mildew and it prevents bacterial proliferation. Furthermore polypropylene is a chemically and biologically inert material, which can even be sterilized.

Another advantage of the box, according to the invention, consists in that it is completely recyclable, after sanitization of the polypropylene sheet, since it is possible to separate the various components, and in particular the metal protection meshes.

Another advantage of the box, according to the invention, consists in that it is completely safe for the animals, it being free from metal points and using only materials, glues and double-sided adhesive tapes that are not harmful to animals.

The safety and health of the animals during transport are crucial, since these are animals for experimentation in cleanrooms.

Another advantage of the box, according to the invention, consists in being able to be stacked telescopically with other, contiguous boxes, thus reducing both the storage encumbrances and the transport costs.

Another advantage of the box, according to the invention, consists in that the box can be stored and transported with the lid already associated with the body of the box.

Another advantage of the box, according to the invention, consists in that the protective mesh covers only some zones of the box, and does not extend over the entire inner surface thereof.

Another advantage of the box, according to the invention, consists in that the final opening of the box occurs, very simply, by way of removing the tear-off strips, thus enabling a safe and easy access to the animals present in the box.

The box thus conceived is susceptible of numerous modifications and variations, all of which are within the scope of the appended claims.

Moreover, all the details may be substituted by other, technically equivalent elements.

In practice the materials employed, provided they are compatible with the specific use, and the contingent dimensions and shapes, may be any according to requirements.

The disclosures in Italian Patent Application No. 102016000076403 (UA2016A005363) from which this application claims priority are incorporated herein by reference.

1-10. (canceled)

11. A box for transporting live animals, particularly of the type of laboratory mice and/or rats, which comprises a base, four side walls and a lid, at least one of said side walls comprising at least one opening for ventilating the internal volume of said box, a protective mesh made of a material such as metal being associated with said at least one opening, wherein said base and said four side walls are made of a material such as polypropylene.

12. The box according to claim 11, wherein said lid is made of a material such as polypropylene.

13. The box according to claim 11, wherein said four side walls are mutually joined by means of hot glue for food use.

14. The box according to claim 11, wherein said lid is pivoted to an upper edge of a first side wall of said four side walls.

15. The box according to claim 14, wherein an upper edge of at least one side wall of said four side walls, other than said first side wall, can be fixed to a corresponding side of said lid by means of double-sided adhesive tape in order to close said lid stably.

16. The box according to claim 11, wherein said side four walls are inclined toward the outside of said box, said box being stackable with contiguous identical boxes.

17. The box according to claim 14, wherein:
one side of said lid is fixed by way of hot glue for food use to the upper edge of said first side wall,
remaining sides of said lid can be fixed by way of double-sided adhesive tape to corresponding edges of the remaining side walls,
said lid is pivoted to said first side wall.

18. The box according to claim 11, further comprising a sheet made of a material such as non-woven fabric which is applied by way of hot glue for food use to said box at said protective mesh.

19. The box according to claim 11, wherein said base and said side walls and/or said lid are die-cut starting from an extruded polypropylene sheet.

20. The box according to claim 11, wherein said protective mesh is arranged exclusively at said at least on opening.
